(19) United States
(12) Patent Application Publication
(10) Pub. No.: US 2017/0072545 A1
(43) Pub. Date: Mar. 16, 2017

(54) ROTATABLE HAMMER DEVICE

(71) Applicant: Halliburton Energy Services, Inc., Houston, TX (US)

(72) Inventors: Robert Cecil Moger, Duncan, OK (US); Brad Robert Bull, Duncan, OK (US)

(21) Appl. No.: 14/851,841

(22) Filed: Sep. 11, 2015

(51) Int. Cl. B25B 19/00; B25B 13/50

(52) U.S. Cl. CPC B25B 19/00; B25B 13/5091

(57) ABSTRACT

An apparatus for rotating and tightening or loosening a threaded device utilized in connection with threaded members. The apparatus includes a reciprocating anvil which is impacted by a rotating hammer to reciprocate the anvil into a lug to rotate a threaded device.

The current disclosure is directed to an apparatus for rotating a threaded device, and more specifically to an apparatus for rotating and thus tightening or loosening a wing union nut, such as a wing union nut utilized in connecting high pressure manifold equipment.

There are a number of applications in the oil and gas industry which require the placement of threaded closure, connecting or tightening devices. Threaded nuts, caps, and other devices may be utilized to close the end of a tube or to connect threaded members together. Many such devices are essentially comprised of a body with an internal thread and a plurality of lugs. Space restraints and sometimes location often make the rotation of the threaded devices difficult. For example, wing union nuts utilized for high pressure manifold equipment are currently tightened using a hammer to hit the lugs on the wing union nut. It is difficult in confined spaces and/or in elevated locations such as a derrick to hammer the wing nut. Oftentimes, the hammer will glance off the lug or will miss the lug completely. Such situations can be a safety hazard to the operator and may also cause damage to other equipment.

### SUMMARY

The current disclosure provides an apparatus for rotating a threaded device onto or off of a threaded member or members. The threaded device may comprise, for example, a threaded closure, connecting or securing device such as a cap device utilized to close a threaded container, or a wing union nut utilized to connect threaded members in high pressure manifold equipment. The threaded device may comprise a threaded body having a plurality of lugs extending from the body. The apparatus of the current invention includes a guide which will support a reciprocating anvil. The reciprocating anvil is positioned to impact one of the lugs so that it will rotate the threaded device in the desired direction.

The apparatus also includes a rotating hammer to repetitively impact and reciprocate the anvil into the lug to rotate the threaded device. The rotating hammer will move between a retracted position and an extended position in which the hammer impacts the anvil. The apparatus may include two rotating hammers, at least one of which repeatedly impacts the anvil.

### BRIEF OF DESCRIPTION OF THE DRAWING

FIG. 1 is a perspective view of the apparatus of the current disclosure.

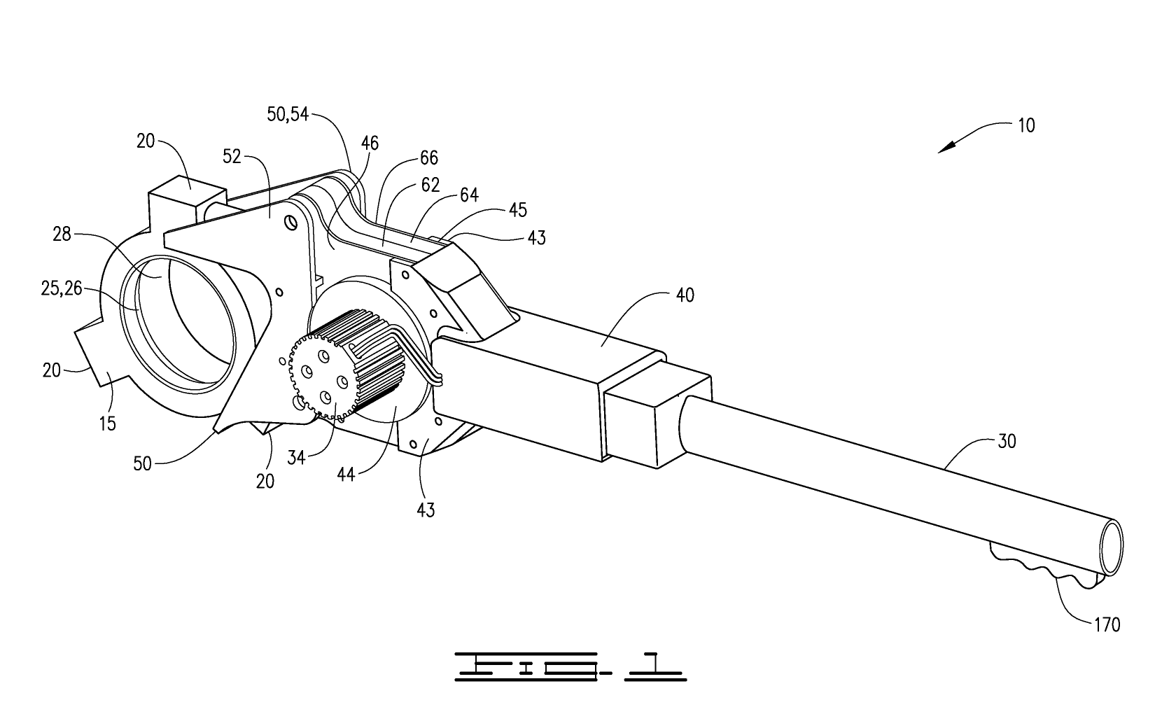

FIG. 2 is a top view of the apparatus of the current disclosure.

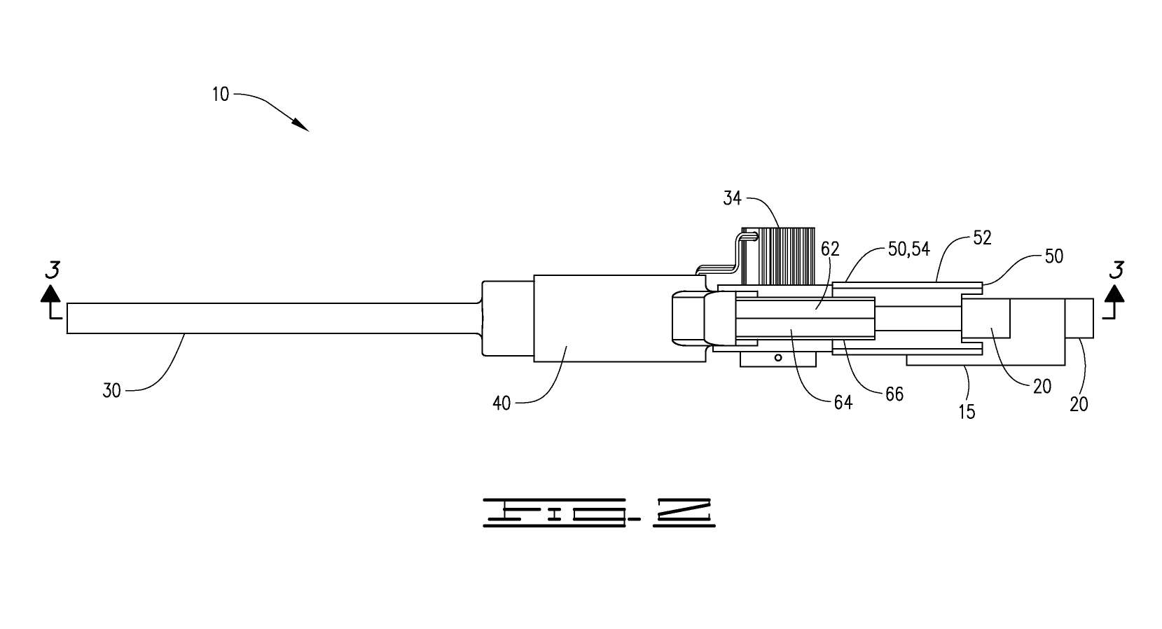

FIG. 3 is a cross-sectional view down the center of the apparatus.

FIG. 4 is a cross-sectional view showing a hammer in an extended position.

FIG. 5 is a cross-sectional view from lines 5-5 of FIG. 4.

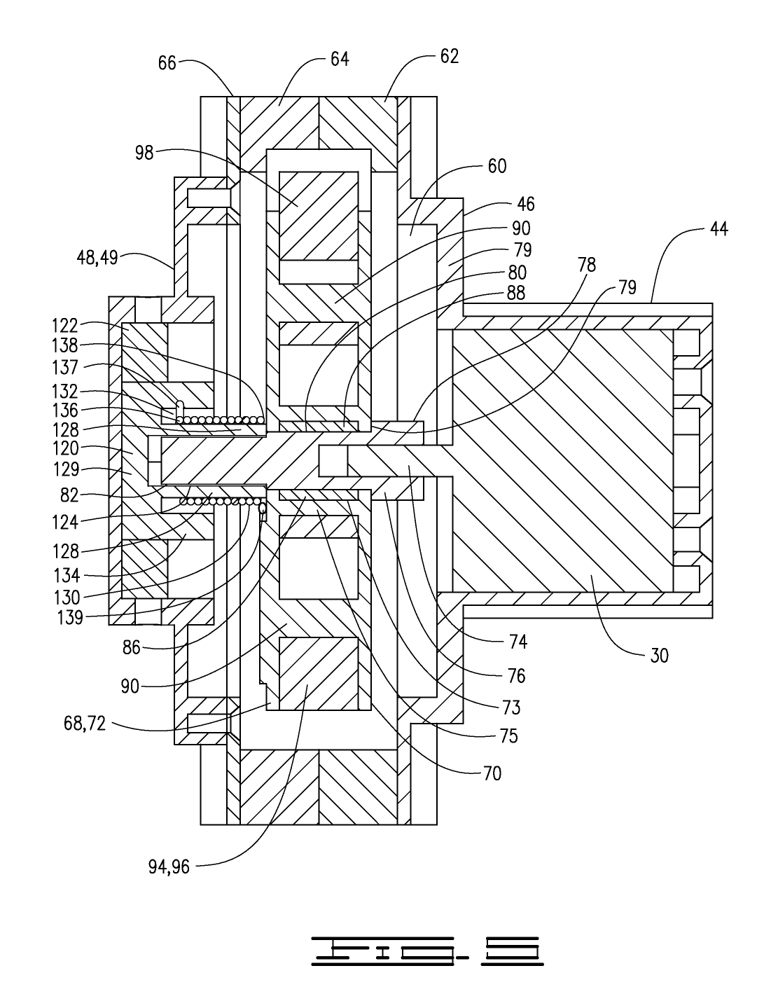

### DESCRIPTION OF AN EMBODIMENT

An apparatus 10 for rotating a threaded device 15 on or off of a threaded member is shown. Apparatus 10 is used to rotate a threaded device 15 which may, for example, be a nut 15 with a plurality of lugs 20. Threaded device 15 has internal threads thereon and is adapted to be threaded onto an externally threaded connector. Threaded device 15 may be wing union nut 15. As known in the art, internal threads 25 may comprise threads 26 and 28 which may be directionally opposite threads so that rotation of wing union nut 15 in one direction will connect two threaded members and rotation in the opposite direction will disconnect the two threaded members. If desired, threaded device 15 can be a standard nut with threads only in one direction to be rotated on and off of an externally threaded member.

Apparatus 10 includes handle 30, a battery 32 and a motor 34 powered by the battery 32. Because of the arrangement disclosed herein, the handle may be only 3-4 feet in length whereas without the assistance of the apparatus 10 as described herein, a handle utilized for wing union connectors and other nuts may often times require a handle as long as ten feet. The current disclosure describes an apparatus 10 that is completely self-contained. Battery 32 and motor 34 are part of apparatus 10 and no external connections and power sources are needed to operate apparatus 10.

Motor 34 may comprise for example a brushless electric motor 34 that included a motor controller 36 positioned in a cavity 38 defined by handle 30. Handle 30, with battery 32 therein may be inserted into a receptacle or receiver 39 defined in a rear portion 40 of a tool body 42. Rear portion 40 may also be referred to as handle receptacle 40.

Motor 34 is mounted in a motor mount 44 which includes an outer plate 46 which may be referred to as a first outer plate 46 of tool body 42. A bearing housing 48 includes bearing plate or second outer plate 49 on the opposite side of tool body 42 from motor mount 44. Motor 30 is connected to battery 32 in a matter known in the art.

A forward support frame 50 will engage threaded device 15. Forward support frame 50 comprises first and second outer plates 52 and 54. A cross bar 56 extends therebetween and, during operation, one of the lugs 20 on threaded member 15 may rest upon cross bar 56. An upper support 58 likewise extends between plates 52 and 54 and may provide support for the apparatus 10 and more particularly for an anvil which will be described in more detail herein. Plates 52 and 54 are spaced such that they may be positioned to engage threaded device 15 when apparatus 10 is in use. Forward support frame 50 will properly align apparatus 10 with threaded device 15, and when an operator applies force to the handle will provide torque to threaded device 15.

Tool body 42 or hammer body 42 defines a body cavity 60. Tool body 42 comprises a first spacer plate 62, a second spacer plate 64 and third spacer plate 66. First outer plate 46, and spacer plates 62, 64 and 66 are positioned between first and second outer plates 52 and 54 of frame 50. Rear portion 40 of tool body 42 has legs 43 that define a channel 45. First, second and third spacer plates 62, 64 and 66 are received in channel 45. Bearing plate, or second outer body plate 49 is mounted to spacer plate 62. The plates can be connected using bolts, screws or other fasteners or means known in the art.

A rotatable housing 68 is positioned in cavity 60 and, as will be explained in detail, is rotated by motor 34. Rotatable housing 68 comprises first and second opposed housing plates 70 and 72 which may be circular outer plates. A central opening 73 is defined by housing plates 70 and 72. Motor 34 has a shaft 74 extending therefrom that connects to a stepped drive shaft 76. Drive shaft 76 may be connected to motor shaft 74 by any means known in the art such as with a key or other means. Drive shaft 76 has first outer diameter, or first portion 78 that is larger than the central radial opening 73 and defines a shoulder 79 thereon. Shoulder 79 may engage first housing plate 70. Second portion or second outer diameter 80 passes through central opening 73 and a third portion or third outer diameter 82 extends into a central opening of a spring retainer as will be described in more detail herein. A central shaft 75 may extend between and be connected to housing plates 70 and 72. An annular space 86 is defined between second portion 80 of shaft 76 and central shaft 75. A magnet 88 is disposed about second shaft portion 80 and fills annular space 86.

A pair of hammer guides or posts 90 likewise extend between and are connected to first and second circular outer plates 70 and 72. A pair of hammers 94, which may be referred to hammers 96 and 98 respectively, are positioned between circular outer plates 70 and 72 and rotate therewith.

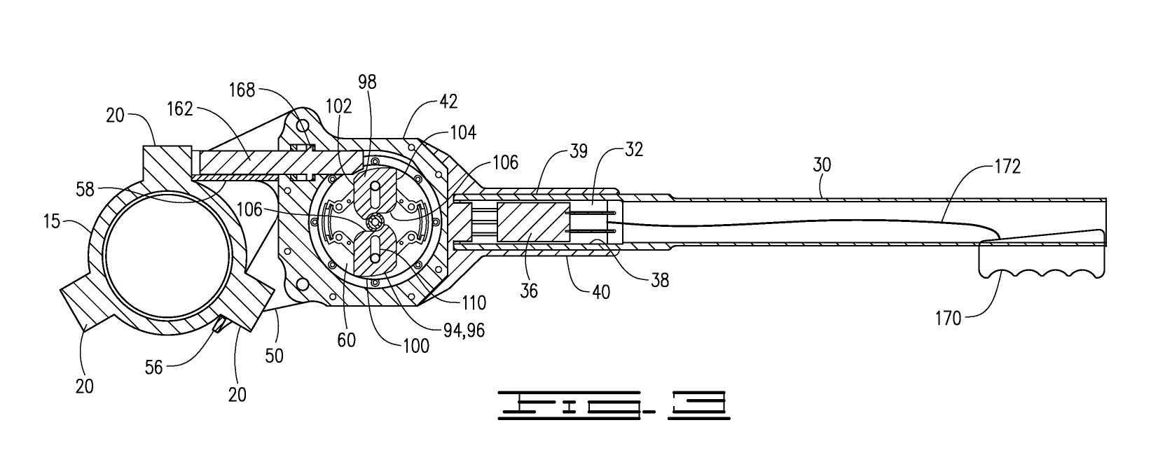

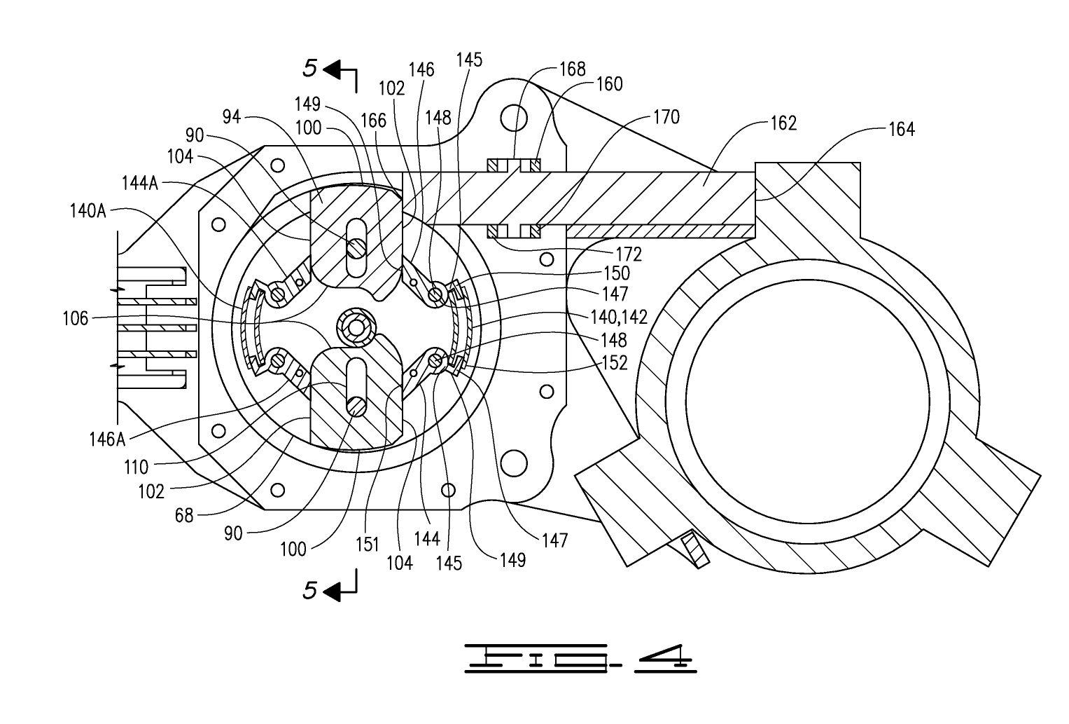

Hammers 94 have a forward or engagement side 102 and a rear or free side 104 and an arcuate upper edge surface 100 that in the retracted position shown in FIG. 3 will generally align with the periphery of housing plates 70 and 72. A lower edge surface 106 of hammers 94 is arcuately shaped and is configured to contact the surface of magnet 88 over at least a portion of the periphery thereof. Hammers 94 have axial slots 110 through which hammer posts 90 extend. Hammers 94 are rotatable and slidable about posts 110 so that hammers 94 may move from the retracted position shown in FIG. 3 to an extended position as shown in FIG. 4 in which one of the plurality of hammers 94 will impact an anvil 162.

A spring retainer 120 is mounted in a bearing 122. Spring retainer 120 defines an opening, which may be referred to as a longitudinal central opening 124 and which receives third portion 82 of drive shaft 76. Drive shaft 76 may be connected to spring retainer 120 by any means known in the art so that spring retainer 120 will rotate therewith. Central opening 124 is defined in a center post 128 of spring retainer 120 and a spring 130 is wound thereabout. Center post 128 connects to a tee-portion 129 which has legs 134 extending therefrom. Legs 134 and center post 128 define an annular space 132 into which spring 130 extends. Spring 130 has first and second ends 136 and 138 both of which have a tab or extension therefrom. First end 136 has tab 137, while second end has a tab or extension 139. Tab 137 is fixed to one of legs 134 and tab 139 is fixed to rotatable housing 68.

A pair of centering or biasing assemblies 140 and 140A include spring or biasing element 142 and first and second lever arms 144 and 146. A pivot pin 148 extends between circular plates 70 and 72 of housing 68. Lever arms 144 and 146 will pivot about pins 148. Ends 145 and 147 of first and second lever arms 144 and 146 have tabs 150 and 152 respectively that will connect or extend into spring 142 and are held in place thereby. Opposite ends 149 and 151 are flat ends will engage the outer edge surfaces 102 and 104 of hammers 96 and 98 respectively. The features of centering assembly 140A are identical to that of centering assembly 140 and are identified with designation A.

An anvil 162 having a hammer or outer end 164 and an internal or impact end 166 extends through a cavity 160 into cavity 60 in tool body 42. A generally circular retaining ring 168 may be connected to or integrally formed with anvil 162 and will limit the travel in cavity 160. Cavity 160 may have a pair or seals 170 and 172 on either side of retaining ring 168 to limit the travel of anvil 162 and to reset anvil 162 prior to a subsequent impact.

In the operation of apparatus 10 motor 30 will cause motor shaft 74 to rotate which will in turn cause shaft 76 to rotate. Shaft 76 rotates inside and may rotate relative to rotatable housing 68. Rotatable housing 68 is rotated by spring 130 which rotates with spring retainer 120. As the shaft 76 rotates, magnet 88 will apply a radially inwardly directed force to both of the hammers 96 and 98 until a rotational speed sufficient to overcome the magnetic force occurs. Once the rotational speed is adequate to overcome the force of magnet 88, one of the plurality of hammers 96 and 98 will extend outwardly and slide along post 128 to the extended or impact position in which it will impact anvil 162 so that the external or outer end 164 of anvil 162 impacts one of the lugs 20 on nut 15. The operator will at the same time apply a force in the direction of rotation which will be aided by cross bar 56 which will pull anvil 162 in the direction of rotation of the nut 15. Because spring 130 rotates housing 68 as opposed to the shaft 76 directly rotating housing 68, the motor 30 will not feel the impact of the engagement of a hammer 94 on anvil 170.

Once impact occurs rotation will slow down and centering assembly 140 or 140A will urge the hammer back to the retracted position. This action will occur until the threaded device 15 is rotated to the desired position on the threaded connectors. The rotating hammers 94 generate a jackhammer effect to rotate the nut 15 onto or off of threaded members. A switch or trigger 170 may be included and connected with a power line 172 that the operator can easily actuate motor 30. Apparatus 10 is fully self-contained so that no external power sources are required. The length of the handle can be much shorter than required with other hammer apparatus, and is adapted for efficient field use.

Thus, it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention as defined by the appended claims.

What is claimed is:

1. Apparatus for rotating a threaded device about a threaded member comprising:
an anvil; and
a plurality of rotating hammers, at least one of the plurality of rotating hammers configured to reciprocate the anvil into repeated engagement with a lug on the threaded device.

2. The apparatus of claim 1 further comprising:
a rotatable shaft; and
a magnet rotatable with the shaft for applying a radially inwardly directed magnetic force to the rotating hammers.

3. The apparatus of claim 1, wherein the rotating hammers are moveable between a retracted position and an extended position in which the hammer strikes the anvil to reciprocate the anvil into the lug on the threaded device.

4. The apparatus of claim 3, further comprising a motor for rotating the shaft, wherein the rotational speed of the shaft urges the at least one hammer into the extended position.

5. The apparatus of claim 4 further comprising:
a biasing assembly for urging the at least one hammer from the extended to the retracted position after the at least one hammer strikes the anvil.

6. The apparatus of claim 1 further comprising a rotatable housing, the hammers being rotatable within the housing.

7. The apparatus of claim 6 wherein the hammers are rotatable and slidable about a center pin from a retracted to an extended position in which the at least one hammer strikes the anvil.

8. Apparatus for rotating a threaded nut having lugs thereon comprising:
an anvil for striking a lug on the threaded nut;
a rotatable housing; and
a hammer configured to rotate with the housing and to move from a retracted position to an extended position for striking the anvil.

9. The apparatus of claim 8 further comprising:
a motor;
a drive shaft extending from the motor; and
a spring affixed to the drive shaft and the rotatable housing;
wherein the drive shaft is rotatable relative to the rotatable housing.

10. The apparatus of claim 9, wherein the spring comprises a wound circular spring with first and second ends, the first and having a tab extending therefrom attached to the housing to rotate the housing as the drive shaft rotates.

11. The apparatus of claim 9, further comprising an outer body defining a cavity, wherein the rotatable housing is positioned at least partially in the cavity.

12. The apparatus of claim 11 further comprising a frame connected to the outer body for engaging the threaded nut.

13. The apparatus of claim 11, wherein the motor is mounted to the outer body.

14. The apparatus of claim 11, wherein the anvil extends into the cavity.

15. An apparatus for rotating a threaded nut about a externally threaded member comprising:
a motor;
a battery for powering the motor;
at least one rotatable hammer mounted in a hammer body and rotated by the motor; and
an anvil configured to impact a lug on the nut in response to rotation of the hammer.

16. The apparatus of claim 15 comprising a handle connected to the hammer body.

17. The apparatus of claim 15 further comprising a magnet for applying a radially inwardly directed force to the at least one rotatable hammer.

18. The apparatus of claim 17 wherein the at least one hammer is moveable from a retracted position to an extended position for striking the anvil.

19. The apparatus of claim 18 wherein the speed of the motor overcomes the magnetic force to move the hammer to the extended position.

20. The apparatus of claim 18 further comprising a biasing assembly for urging the at least one hammer from the extended to the retracted position.
